(19) United States
(12) Patent Application Publication
(10) Pub. No.: US 2009/0234174 A1
(43) Pub. Date: Sep. 17, 2009

(54) SOLID-PHASE ACTIVATION OF BAUXITE REFINERY RESIDUE FOR HEAVY METALS REMEDIATION

(75) Inventors: Andrea L. Westman, New York, NY (US); Jimmy V. Rouse, Golden, CO (US); James P. Jonas, JR., Westminister, CO (US); Neil M. Bardach, Coconut Grove, FL (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: GEOCHEM Remediation LLC, Coconut Grove, FL (US)

(21) Appl. No.: 12/401,867

(22) Filed: Mar. 11, 2009

Related U.S. Application Data
(60) Provisional application No. 61/035,569, filed on Mar. 11, 2008.

(51) Int. Cl. A62D 3/32; A62D 101/43

(52) U.S. Cl. 588/412

(57) ABSTRACT

A method for solid-phase activation and neutralization of bauxite refinery residue (“red mud”) comprises the steps of preparing a quantity of untreated red mud having a moisture content of approximately 15 percent by weight, introducing a quantity of at least one reagent, and mixing in a mixer the quantity of untreated red mud and the quantity of at least one reagent. The mixing step is adapted to expose reaction sites at the nano-particle level. In one embodiment, the at least one reagent is calcium chloride and magnesium chloride salts. In another embodiment, an acid is introduced to the quantity of untreated red mud and the quantity of at least one reagent. A neutralized and activated red mud formed by the process is suitable for heavy metals remediation in soil and water.

### CROSS-REFERENCE TO RELATED APPLICATIONS

This application claims the benefit of and priority from U.S. Provisional Patent Application Ser. No. 61/035,569, filed Mar. 11, 2008, and entitled: Solid-Phase Activation of Red-Mud Residue for Metals Remediation.

### FIELD OF THE INVENTION

The present invention relates to a method for solid-phase neutralization and activation of bauxite refinery residue for creation of a range of products for remediation of heavy metals, metalloids, and radionuclides (hereinafter referred to as “heavy metals”), and to the products thus created.

### BACKGROUND OF THE INVENTION

Bauxite ore is one of the most important ores of aluminum, and comprises approximately 30-50% alumina. The most common industrial method of extracting alumina from bauxite ore is known as the Bayer process. In the Bayer process, the bauxite is crushed, slurried with a solution of sodium hydroxide, and pumped into large pressure tanks, or digesters. The bauxite is subjected to steam heat and pressure in the digesters, and this caustic leaching process slowly dissolves the alumina where it reacts with the sodium hydroxide to form a saturated solution of sodium aluminate. The solution containing the sodium aluminate is placed in a special tank where the alumina is precipitated out of the solution. The insoluble residue that remains, which is bauxite ore from which the alumina has been extracted, is the source material for the present invention.

Bauxite ore from which the alumina has been extracted using the Bayer process may be termed bauxite refinery residue and is commonly known as “red mud”. Red mud typically contains finely divided iron-, aluminum-, and titanium oxides and oxyhydroxides. Also present are large amounts of sodium hydroxide and sodium carbonate, so red mud is highly caustic, typically having a pH greater than 13. Due to the percentage of alumina found in bauxite ore (30-50%), approximately one to two tons of red mud are generated for every one ton of alumina produced. To handle the enormous quantity of highly alkaline red mud generated in the alumina extraction process, the red mud is typically stored in disposal sites such as containment reservoirs (red mud “ponds”) near the refinery. Over time, the red mud ponds form a crust several feet thick, while the moist red mud underneath retains its original moisture content almost indefinitely.

The red mud disposal sites pose dire environmental hazards due to the high pH of red mud. For example, leakage of the alkaline supernatant and pore water into the ground leads to contamination of the soil and ground water. Overflow of the disposal site caused by heavy rains or dam structural failure similarly threatens surrounding soil, surface and ground water, and habitation. The dry crust on top of the pond may produce red mud dust, which may carried by the wind for miles and contaminate surrounding areas. All of these problems are a result of the high pH of the red mud. Therefore, neutralizing the red mud, that is, lowering its alkalinity, would itself be environmentally beneficial. However, since neutralized and activated red mud is useful for remediating a broad range of environmental problems in a variety of locations distant from the red mud ponds, it is necessary not only to neutralize and activate the red mud but to prepare it for transport to and use in those other locations.

One method of neutralizing red mud has been to add common sea water until the pH of the suspension is lowered to approximately 9.0 through the reaction of the red mud with calcium and/or magnesium ions contained in the sea water. It has been found that if an untreated red mud has a pH of about 13.5 and an alkalinity of about 20,000 mg/L, the addition of up to 17 volumes of typical sea water will reduce the pH to between 9.0 and 9.5 and the alkalinity to about 300 mg/L. This procedure, which has never been implemented in a process-controlled manufacturing operation, results in an inconsistent material composition and the introduction of substantial amounts of sodium and potassium chloride naturally occurring in the sea water that is not efficacious in the neutralization process. Before red mud neutralized in this manner is suitable for use, it must be washed to remove porewater salts. Before it can be economically transported, it must then be dried to achieve a powder-like substance. This process, if implemented on a full scale, would require the introduction of substantial amounts of fresh water for rinsing the treated material, substantial amounts of energy for dewatering and drying, and the discharge of enormous quantities of modified sea water and rinse water into the environment.

Thus, although neutralizing red mud with sea water may be effective at the laboratory-level, extrapolating the process to a large-scale, industrial site is not economically feasible. Even though sea water is cheap and abundant, it must be co-located near the red mud disposal site. If not, transportation and logistic costs rise dramatically because (1) transporting the highly alkaline red mud to the sea water is an environmental hazard; alternatively, (2) transporting water to the site of the red mud is prohibitively expensive. Also, large-scale efforts to dry the mixture into powder consume enormous amounts of energy, further reducing the advantages of the process. Finally, disposing of modified sea water and rinse water is expensive and requires expensive and time-consuming permitting and monitoring to ensure the water quality standards of the receiving water are not compromised.

Despite the apparent disadvantages of neutralizing red mud in this fashion, recent laboratory research has shown neutralized red mud residue can be used to chemisorb arsenic from drinking water. Laboratory research has also shown that activating the red mud increases the arsenate removal capacity. One such activation process involves refluxing the neutralized red mud in hydrochloric acid (HCl), adding ammonia for complete precipitation, filtering, washing with deionized water, and calcining at 500° C. (932° F.) for two hours.

Although the disclosed method of activating red mud may be useful in a laboratory, the process is not economical for a process-controlled industrial operation. The cost of material produced properly in this fashion is very high, with the result that remediation of many environmental problems is needlessly costly.

### SUMMARY OF THE INVENTION

In view of the background, it is therefore an object of the present invention to provide a method for the neutralization and activation of untreated red mud that may be economically performed on an industrial scale.

According to one embodiment, a method for solid-phase neutralization and activation of red mud comprises the steps of preparing a quantity of untreated red mud having a moisture content of approximately 15 percent by weight, introducing a quantity of at least one reagent to the quantity of untreated red mud, and mixing in a mixer the quantity of untreated red mud and the quantity of at least one reagent. The mixing step is adapted to expose reaction sites at the nano-particle level.

According to another embodiment of the invention, the at least one reagent is calcium chloride salt. According to another embodiment of the invention, the at least one reagent is magnesium chloride salt. And, in yet another embodiment of the invention, the at least one reagent is calcium chloride salt and magnesium chloride salt.

According to another embodiment of the invention, an acid may be introduced to the quantity of untreated red mud and the quantity of at least one reagent in an amount sufficient to activate the red mud, that is, to increase the number of sites on the material to which heavy metals can bind.

According to another embodiment, the present invention provides a material which, due to its simplified manufacturing process and method of packaging compared to earlier forms of activated red mud, allows its economical use for remediation of environmental problems for which remediation was previously too costly.

According to another embodiment, a material is formed by this method that has an enormous capacity to remove heavy metals from water or immobilize those heavy metals in soil because the removal mechanism is related to crystallization of heavy metals onto the nano-scale particles that comprise neutralized and activated red mud.

### BRIEF DESCRIPTION OF THE DRAWINGS

The novel features that are characteristic of the preferred embodiment of the invention are set forth with particularity in the claims. The invention itself may best be understood, with respect to its organization and method of operation, with reference to the following description taken in connection with the accompanying drawings in which:

FIG. 1 schematically illustrates an example manufacturing method; and

FIG. 2 schematically illustrates one embodiment of the manufacturing method of FIG. 1.

### DETAILED DESCRIPTION

Heavy metal contamination from mining and other industrial sites presents a significant human and animal health hazard from: the contamination of drinking water supplies from those heavy metals; the insinuation of those heavy metals into agricultural products fed by that contaminated water; the reduction of pH of streams and waterways into which that contamination is introduced; and the introduction of heavy metals into those waterways, which endangers the health of fish and other wildlife. In addition, many sources of drinking water are contaminated by naturally occurring heavy metals. Consequently, there is a clear need to develop compositions and application strategies that will mitigate the effects of heavy metal contamination on world-wide water supplies. Such compositions and application strategies will substantially improve drinking water supplies and food production economics.

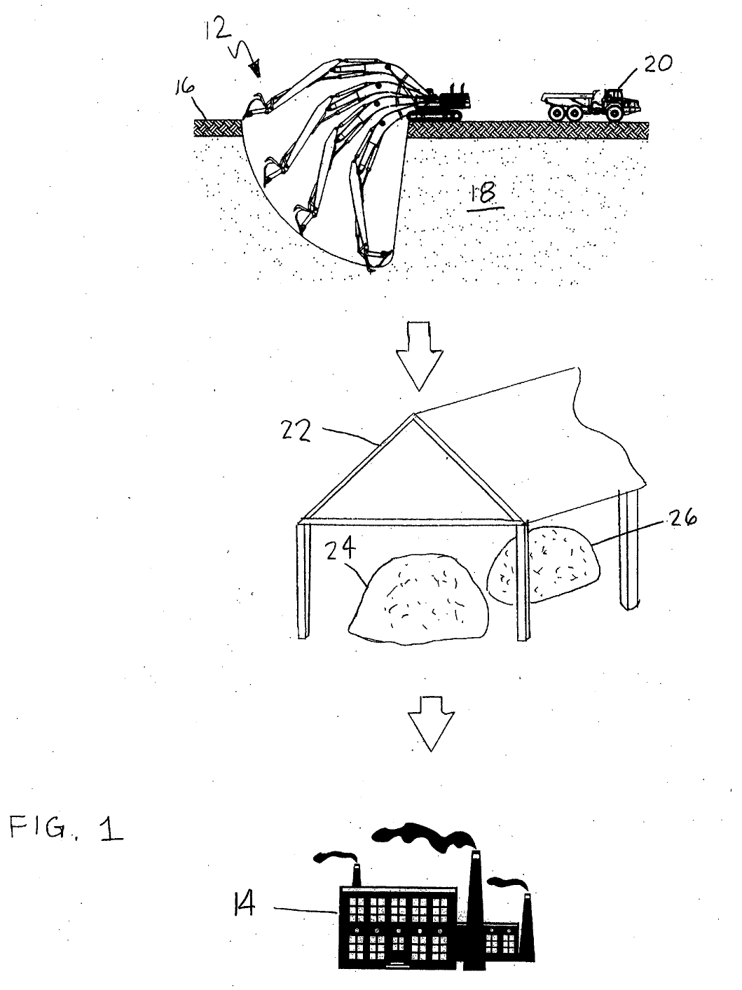

Referring to FIG. 1, the present invention provides a method for the solid-phase neutralization and activation of red mud involving specific actions in the mining of the red mud residue from red mud ponds and the mixing of additional reagents in high solids content form. In a first embodiment, the red mud used in the inventive method described herein is obtained directly from a red mud pond 12, and a production facility 14 is preferably located nearby so transportation of highly alkaline red mud is minimized. Core samples taken from drilling activities in a typical red mud pond indicate that an upper portion of the red mud comprises a crust 16 that is commonly dry and cemented, to a depth of approximately 6 feet. A lower portion of the pond 12 comprises untreated red mud 18 that is moist and soft. Evidence shows that the drying and cementing in the crust 16 renders the particles and clusters of particles refractory in nature, and thus much less reactive. Therefore, mining of the raw material to be used in the present embodiment is preferably conducted in a pit below the depth of drying and dehydration.

Excavated red mud 18 from the pond 12 may be delivered by a transport vehicle 20, such as a dump truck, to a temporary storage facility 22. There, each load may be measured for pH, water content, and particle size. Preferably, the particle size in any one dimension shall be no greater than 0.50 millimeters (0.02 inches). The temporary storage facility 22 may be adapted to stage the untreated red mud 18 for processing. For example, a first pile 24 of red mud 18 may be generated to support current work flow, for example daily operations. A second pile 26 of red mud 18 may be generated to support on-going operations, for example feedstock to be utilized the following day. In this manner, transport vehicles 20 delivering the red mud 18 from the pond 12 do not interfere with any loading vehicles transporting the red mud 18 to the production facility 14.

The raw material, or untreated red mud 18, typically contains finely divided iron-, aluminum-, and titanium oxides and oxyhydroxides. The moist residue is highly alkaline, as a result of the leaching of the ground bauxite ore with sodium hydroxide solution in the Bayer process. Also present, then, are large amounts of sodium hydroxide and sodium carbonate, so the untreated red mud 18 may have a pH of over 13, typically 13.5. It should be noted, however, that due to differences in the initial composition of the bauxite ore, some red mud ponds may have a pH as low as 9.6 and an alkalinity of about 5,000 milligrams per liter. Experimental methods have determined the finely divided particles remain in suspension, and the moisture content of the untreated red mud 18, although varying somewhat from pond to pond, is about 15% by weight. In some red mud ponds, the moisture content of untreated accumulations may be as low as 10%. In other red mud ponds at a different locale, the moisture content of untreated accumulations may be as high as 20%.

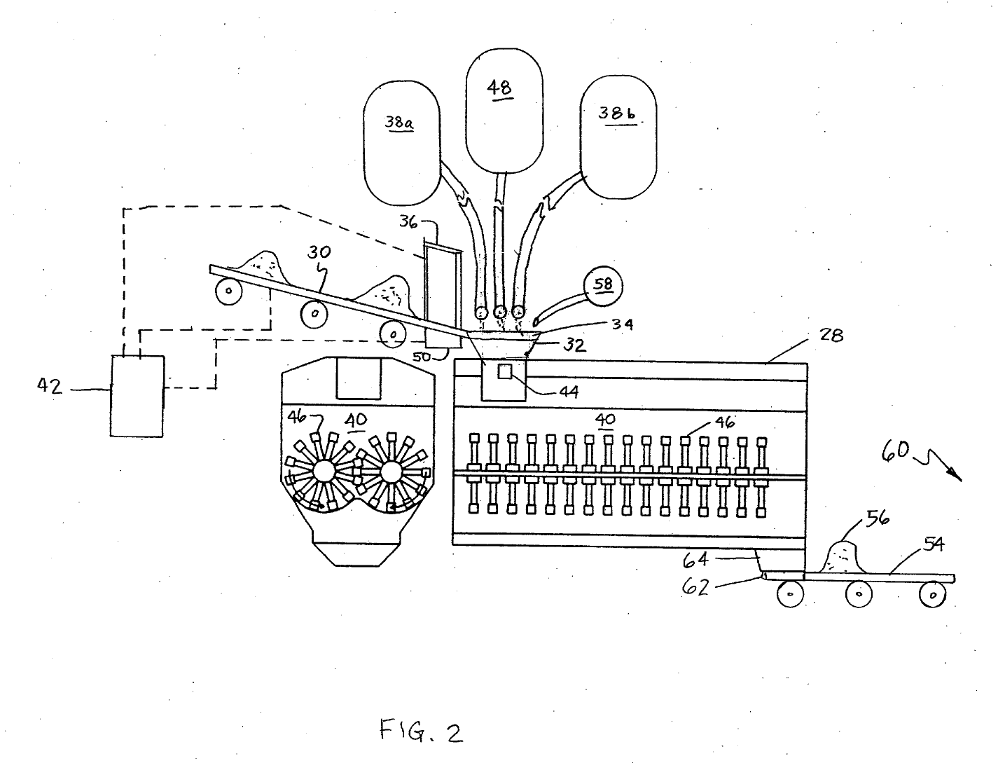

The untreated red mud 18 may be transported from the temporary storage facility 22 to the production facility 14 by any convenient means, such as a front end loader. The red mud 18 may be prepared for the neutralization process by adjusting its moisture content to approximately 15% by weight. For example, the red mud 18 may have a small amount of water added to it, or it may be air dried. Referring to FIG. 2, the production facility 14 includes a mixer 28 having a front feed conveyer 30 leading to a hopper 32. The hopper 32 may be fitted with a sifting apparatus 34, for example grizzly bars, configured for approximately 25 millimeter (1 inch) spacing to prevent the entry of large contaminants. Oversized materials and contaminants separated by the sifting apparatus 34 may be returned to the red mud storage pond 12. The hopper 32 may be further equipped with a suitable metal detector 36 such that any metal trash in the raw red mud 18 may be detected prior to entry into the mixer 28. Detection of metal on the front feed conveyor 30 will cause the conveyor to stop and allow removal of the metal contaminant manually. Alternatively, the conveyor may be under an electromagnet to magnetically remove metal.

The hopper 32 is adapted to feed the red mud 18 and at least one reagent 38 into a central mixing region 40 of the mixer 28. A controller 42 may be coupled to the front feed conveyer 30 for controlling a feed rate to the hopper 32. In the disclosed embodiment, the feed rate is a predetermined value of approximately 8.0 metric tons (8.8 tons) per hour. The controller 42 may be programmed not to exceed an established feed rate for a given comminution size, as will be discussed below. A limit switch 44 in proximity to the hopper 32 may also be coupled to the controller 42 to detect any back-up of material in the hopper. The limit switch 44 sends a signal to the controller 42, and the controller commands the front feed conveyor 30 to temporarily shut down.

Unlike prior art methods of neutralization and/or activation that include a process step for adding large volumes of sea water to the mixture, the inventors have discovered that the step of adding water to the mixing process may be eliminated. That is, there is enough moisture in the untreated red mud mined from the pond to carry out the inventive process disclosed herein. For this reason, the neutralization and activation process disclosed herein is referred to as a solid-phase reaction. The research conducted by the inventors has demonstrated that the neutralization and activation of the red mud 18 occurs at the nano-particle level in a solid-phase reaction, induced by the physical contact between the red mud 18 and the neutralizing/activating reagents 38. The reaction time is reduced by the presence of the small amount of moisture naturally occurring in the mined red mud 18. The inventors' tests have confirmed that one important element of the neutralization and activation process is the thorough mixing of the requisite reagents, rather than any introduction of additional moisture.

Accordingly, the mixer 28 is adapted to thoroughly mix the red mud 18 paste and the solid reagent(s) 38 so as to expose reaction sites at the nano-particle level. One example mixer 28 that has been utilized with success is a pug mill. A pug mill is typically a machine in which materials are simultaneously ground and mixed with a liquid. As used in the present embodiment, the pug mill includes mixing elements 46 that grind and mix the red mud 18 to establish a desired communition size of the particles. As mentioned earlier, the feed rate may be limited to establish a desired comminution size. Other examples of appropriate mixers 28 include cement mixers and mortar mixers.

The method of the present invention calls for the introduction of at least one reagent 38 into the red mud 18 to effect the neutralization and activation of the material. In one embodiment, the reagent 38 is a solid form of calcium and magnesium salts. In one example, the solid form of calcium and magnesium is calcium chloride salt 38a and magnesium chloride salt 38b. The salts may be a highly concentrated suspension in water for ease of delivery into the hopper 32. For activation, the sodium ions in the untreated red mud 18 are replaced by cation exchange with the calcium and magnesium ions to form low-solubility calcium and magnesium forms of alkalinity.

Activation may be accomplished by the concurrent addition of an acid 48 with the reagents 32 added into the mixer 28 and mixed to achieve solid-phase reactions of neutralization, cation exchange, and activation. In the disclosed embodiment, the acid 48 is hydrochloric acid diluted in water. The pH of the mixture may be measured in the central mixing region 40 and used to trim the flow rates of the concentrated salts 38a, 38b to achieve an outlet pH of 9.2 or lower.

Additional reagents may be added to the mixer 28 to eliminate other contaminants. For example, ferrous ions in the form of ferrous chloride or ferric chloride may be introduced to the red mud 18 mixture.

An integral weigh scale 48 on the front feed conveyor 30 may determine the mass of untreated red mud 18 transferred to the mixer 28 in a given time. The weigh scale 48 may be used in the fine control of the rate of delivery for the reagent(s) 38 to assure proper neutralization and activation while maintaining a preset solids concentration of 75-80%. Coarse control of rate of addition may be set by known average dilution and neutralization requirements from statistical determinations of untreated red mud to dry weight and neutralization requirements.

The mixer 28 may be equipped with at least one pump suitable for the introduction of calcium chloride 38a and magnesium chloride 38b into the communited red mud 18. The calcium and magnesium chlorides 38a, 38b may be stored in tanks 54 sufficiently large to accommodate required supplies based on supplier shipment schedules, for example. The tanks 54 may be equipped with pumps of suitable strength to allow introduction of the salts 38a, 38b without excessive nozzle clogging.

The calcium chloride 38a and magnesium chloride 38b salts may be added in sufficient quantities to effect neutralization of the red mud 18 to product specification, and at slurry rates suitable for maintaining solids density of the final product. In the disclosed embodiment, wherein the feed rate of the untreated red mud 18 is approximately 8 metric tons (8.8 tons) per hour, the calcium chloride 38a is preferably added at a rate of approximately 0.6 cubic meters (21.2 cubic feet) per hour, and the magnesium chloride 38b is preferably added at a rate of approximately 3.4 cubic meters (120 cubic feet) per hour.

In the embodiment disclosed herein, the front feed conveyer 30 may be loaded with a 2 metric ton (2.2 ton) batch of untreated red mud 18 in 2-5 minutes. The neutralization and activation reactions are completed within the central mixing region 40 in approximately 5-8 minutes. Thus, the total processing time for the 2-ton batch ranges from 7 to 13 minutes.

The resultant materials composition, or treated red mud 56, will preferably have a reaction pH of less than 9.3. The treated red mud 56 will have a solids density of approximately 85% by weight. Small quantities of an inert hydrophilic substance 58 may be added to aid in material handling. In one example, the hydrophilic substance 58 is calcium sulfate.

Once reactions are complete, the treated red mud 56 may need only a slight amount of air drying, perhaps by spreading on a covered concrete slab, before being sufficiently dry to ship. Significantly, the dewatering or drying step disclosed in prior art neutralization and activation processes may be eliminated by the method of the present invention.

A rear conveyer 54 delivers the treated red mud 56 to a packaging area 60. Vibrating screens 62 may be placed at a discharge hopper 64 to separate large particulates. In one example, two screens in parallel may be used for the separation of solids greater than 500 microns. The separation screens 62 may be washed with air jets, for example, to prevent clogging during a manufacturing run. The screened treated red mud 56 may be transferred directly to a storage container for shipment to the intended point of use. In one example, the storage container is a one-ton Super Sack®, manufactured by B.A.G. Corp. of Dallas, Tex. Full containers may be moved to a contained temporary storage area with controlled drainage close to the production facility. Oversized material consisting primarily of agglomerates of treated red mud 56 may be transferred to a storage site for use in projects with suitable material size specifications.

Quality control measures may be undertaken to assure the treated red mud 56 meets customer specifications. Discrete samples of treated red mud 56 may be taken every hour and pooled for each production day for subsequent quality analysis at the on-site laboratory. Once product quality for a specified period has been ascertained, product may then be transferred to the bulk storage facility for subsequent transport.

In another embodiment of the present invention, a method for solid-phase activation of red mud is disclosed wherein treated red mud 56 is formed using neutralized red mud 62 instead of untreated red mud 18. One example composition of the dry, neutralized red mud 62 is presented in Table 1. The untreated red mud 18 may have been neutralized by a third party, for example, and stored at a storage site. In this method, an amount of water may be added to the composition to bring the moisture content to the level naturally occurring in the red mud pond 12, approximately 15% by weight. The water may be added prior to entry within the hopper 32, or may be added to the central mixing region 40. The present method does not include the step of adding the acid 48, since the mixture has already been neutralized. All other process steps in the method are similar to the steps previously discussed.

TABLE 1
Chemical Analysis of Dry Red Mud

| | Weight | | Weight |
|---|---|---|---|
| Constituent | percentage | Constituent | percentage |
| Fe₂O₃ | 37.3 | Na₂O | 8.3 |
| Al₂O₃ | 17.6 | CaO | 4.4 |
| SiO₂ | 16.9 | Loss in analyzing | 7.2 |
| TiO₂ | 5.6 | | |

The treated red mud 56 made by the methods described herein is a dry (less than 15% water by weight) red solid that consists of a complex mixture of minerals with an acid neutralizing capacity of 2.5-7.5 moles of acid per kilogram of treated red mud) and a very high capacity for binding heavy metals, metalloids, and radionuclides; it also has a high capacity to trap and bind phosphate and some other chemical species.

The treated red mud 56 made by the methods of the present invention is capable of (1) removing heavy metals, metalloids, and radionuclides from aqueous solution, as well as (2) converting them into non-leachable form in contaminated soil, sediment, and sludge. The treated red mud 56 can be produced in various forms to suit individual applications, all with near-neutral soil reaction pH (less than 9.5 and often between 8.2 and 8.6) in addition to high acid neutralizing capacity. The soil reaction pH of the treated red mud 56 is sufficiently close to neutral and its Toxicity Characteristic Leaching Procedure (TCLP) values are sufficiently low that it can be transported and used without the need to obtain special permits.

The compositions of the invention may be provided in the form of a blend or they may be formulated as mixtures of powders, granules, pellets or tablets of the separate components, or as powders, granules, pellets or tablets composed of the mixed components. The choice of the form of the composition is made on the basis of treatment protocols and disposal requirements, if any. If the components are applied separately, treatment protocols may but will not always require that they be applied in a specific sequence. If the components are applied separately, the time between the applications may vary greatly with extant conditions and treatment requirements.

To this end, the inventors have adapted the treated red mud 56 to take forms that are useful in treating environmental contamination by heavy metals. In one example, the treated red mud 56 is slurried with potable water for injection into the subsurface. The slurry may also be sprayed onto a pond, where it removes heavy metals and raises the pH of the water as it moves through the water column. In another example, the treated red mud 56 is mixed or tilled directly into contaminated soil, sediment or sludge material for heavy metals and radionuclide fixation. In yet another example, the treated red mud 56 is formed into pellets. A stream of water passes over and between the pellets to treat contamination.

The amount of treated red mud 56 applied will be readily determined by persons schooled in the science and skilled in the art, based on known application rates, after taking account of the fact that in the methods of the present invention substantially all the material applied is available for heavy metals reduction with little lost to waterways. Furthermore, the nearly limitless capacity of the material to trap heavy metals typically results in the completion of a treatment protocol with a single application.

### EXAMPLES

### Example 1

### Reduction of Ground Water Contamination from Treating Soil Contaminated with Arsenic and Chromium

The owner of a property previously used for many years to treat wood with a Copper-Chromium-Arsenate (“CCA”) compound mobilized a drilling company to its site and injected the treated red mud 56 into twenty four bores drilled specifically for that purpose. First an oxidant was injected to improve the ability of the treated red mud 56 to bind the arsenic present in the soil. Then the treated red mud 56 was injected in a thin slurry at high pressure to create small fractures in the subsurface and allow the activated red mud to reach as much of the contaminated soil as possible. Water samples were taken from monitoring wells immediately prior to the treatment to establish background levels of contamination; samples taken a week after completion of the injections showed arsenic and chromium at non-detectable levels. The wells have been sampled routinely since the treatment and continue to show arsenic and chromium at non-detectable levels.

Table 2 shows the arsenic and chromium concentrations prior to treatment and at six (6) and twenty-nine (29) week intervals after testing. The data show that the introduction of the treated red mud 56 had an immediate and lasting impact on the groundwater contamination created by the soil.

TABLE 2
Effect on Ground Water Of a Single Treatment Of
Soil Contaminated with Arsenic and Chromium

Parts per Million

| | Chromium | Arsenic |
|---|---|---|
| Pre-Treatment | 0.096 | 0.640 |
| After GeoBind ™ Treatment | | |
| 6 Weeks Later | <0.010 | <0.005 |
| 29 Weeks Later | <0.010 | <0.005 |

### Example 2

### Effect on Mine Drainage of a Single Treatment of Contaminated Mine Tailings

This project involved laboratory column testing of mine tailings contaminated with manganese, cobalt, nickel, and zinc. Controlled water samples representing approximately one year of rainfall were introduced into columns filled with representative tailings from an operating gold mine. Various amounts of the treated red mud 56 were mixed with the soil in each column, and the metal contamination in the water exiting the columns was measured. Table 3 shows the heavy metal contamination present in the water emanating from untreated soil in comparison to the heavy metal contamination emanating from soil treated with activated red mud.

TABLE 3
Effect on Mine Drainage Of a Single Treatment
Of Contaminated Mine Tailings

| | Parts per Million | | | |
|---|---|---|---|---|
| | Manganese | Cobalt | Nickel | Zinc |
| Untreated | 4.490 | 0.101 | 0.496 | 0.218 |
| After GeoBind ™ Treatment | 0.016 | 0.031 | 0.039 | 0.011 |

One advantage of the current method over prior art processes is that the amount of chloride introduced into the treated red mud 56 is reduced, making the treated red mud 56 far more suitable for remediation of environmental problems.

Another advantage is that the energy requirements for the neutralization process are reduced.

Another advantage is that much less harm to the environment is risked from discharge of large quantities of modified sea water followed by large quantities of rinse water.

Yet another advantage is that worker safety is improved by dramatically reducing the use of acid in the neutralization process.

A further advantage of the disclosed method is that the ultimate material cost to the end user is reduced; thereby improving the likelihood that elimination of heavy metal contamination from water can be done in an affordable fashion.

Yet a further advantage is that the activation and neutralization times are reduced due to the insolubility of the material, often resulting in remediation being completed in a single step rather than requiring multiple applications as is often the case with other treatment materials and protocols.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

We claim:

1. A method for solid-phase neutralization and activation of bauxite refinery residue, comprising the steps of:
preparing a quantity of untreated red mud having a moisture content of approximately 15 percent by weight;
introducing a quantity of at least one reagent to the quantity of untreated red mud;
mixing in a mixer the quantity of untreated red mud and the quantity of at least one reagent, the mixing step adapted to expose reaction sites at the nano-particle level; and
forming a treated red mud thereby.

2. The method according to claim 1 wherein the at least one reagent is selected from the group consisting of calcium chloride and magnesium chloride.

3. The method according to claim 1, wherein the at least one reagent is calcium chloride and magnesium chloride.

4. The method according to claim 3 wherein the calcium chloride and magnesium chloride are a highly concentrated suspension in water.

5. The method according to claim 1 wherein the untreated red mud has a pH greater than 9.6 and an alkalinity of at least 5,000 milligrams per liter.

6. The method according to claim 1 further comprising the step of introducing an acid to the quantity of untreated red mud and the quantity of at least one reagent.

7. The method according to claim 6 wherein the acid is hydrochloric acid.

8. The method according to claim 1 further comprising the step of adding a hydrophilic substance to the quantity of untreated red mud.

9. The method according to claim 8 wherein the hydrophilic substance is calcium sulfate.

10. The method according to claim 1 further including the step of air drying.

11. The method according to claim 1 wherein the step of preparing the quantity of untreated red mud includes adding an amount of water to achieve the moisture content of approximately 15 percent by weight.

12. The method according to claim 1 wherein the red mud is neutralized red mud powder.

13. The method according to claim 1 wherein the step of preparing the quantity of untreated red mud includes drying the untreated red mud to achieve the moisture content of approximately 15 percent by weight.

14. The method according to claim 1 wherein the step of preparing the quantity of untreated red mud includes removing particles larger than 0.50 millimeters, as measured in any one dimension.

15. The method according to claim 1 wherein the method further comprises the step of introducing ferrous chloride.

16. The method according to claim 1 wherein the method further comprises the step of introducing ferric chloride.

17. In a production facility comprising a front feed conveyor coupled to a hopper, a mixer coupled to the hopper, and a rear conveyer coupled to the mixer, a method for preparing a heavy metals remediation material composition, comprising the steps of:
supplying a quantity of untreated red mud onto the front feed conveyer at a feed rate, the untreated red mud being approximately 15 percent water by weight;
introducing to the hopper a quantity of at least one reagent;
mixing a materials composition in the mixer to neutralize the untreated red mud, the materials composition comprising the untreated red mud and the at least one reagent;
forming a treated red mud thereby; and
packaging the treated red mud.

18. The method of claim 17 wherein the at least one reagent is calcium chloride salt and magnesium chloride salt.

19. The method of claim 17 further including the step of introducing to the hopper an acid in sufficient quantity to lower the pH of the material composition in the mixer to less than 9.2.

20. The method of claim 17 further including the step of air drying the treated red mud to achieve a final water content in the range of 15 to 20 percent by weight.

21. The method of claim 17 wherein the mixer is a pug mill, and the mixing step further includes grinding.

22. The method of claim 17 further comprising a controller coupled to the front feed conveyer for controlling a feed rate.

23. The method of claim 22 wherein the feed rate is a predetermined value based upon a weight of the untreated red mud.

24. The method of claim 23 wherein the predetermined value of the feed rate is approximately 8 metric tons per hour.

25. The method of claim 24 wherein the at least one reagent is calcium chloride salt and magnesium chloride salt, the quantity of calcium chloride being approximately 0.6 cubic meters per hour and the quantity of magnesium chloride being approximately 3.4 cubic meters per hour.

26. The method of claim 22 wherein the feed rate is responsive to a predetermined comminution size of the materials composition.

27. The method of claim 22 further comprising a weigh scale coupled to the front feed conveyer, the controller coupled to the weigh scale, wherein the feed rate is adjusted responsive to a reading on the weigh scale.

28. A heavy metals remediation material composition made by the process, comprising preparing a quantity of untreated red mud having a moisture content of approximately 15 percent by weight, introducing a quantity of at least one reagent to the quantity of untreated red mud, mixing in a mixer the quantity of untreated red mud and the quantity of at least one reagent to expose reaction sites at the nano-particle level, and forming a treated red mud thereby.

29. The material composition of claim 28 wherein the at least one reagent comprises calcium chloride and magnesium chloride.

30. The material composition made by the process of claim 28 further comprising introducing an acid to the quantity of untreated red mud and the quantity of at least one reagent in an amount sufficient to lower the pH to less than about 9.2.

31. The material composition made by the process of claim 28 wherein the treated red mud is formed into pellets.

32. The material of claim 28 wherein the process further comprises the step of adding water to the material to provide a slurry.
